(19) United States
(12) Patent Application Publication
(10) Pub. No.: US 2017/0048607 A1
(43) Pub. Date: Feb. 16, 2017

(54) HEADSET

(71) Applicant: Sennheiser electronic GmbH & Co.KG, Wedemark (DE)

(72) Inventor: Manfred KÜRBIS, Wedemark (DE)

(73) Assignee: Sennheiser electronic GmbH & Co.KG, Wedemark (DE)

(21) Appl. No.: 15/124,781

(22) PCT Filed: Mar. 11, 2015
(86) PCT No.: PCT/EP2015/055075

§ 371 Date: Sep. 9, 2016

(30) Foreign Application Priority Data
Mar. 11, 2014 (DE) 10 2014 204 405.7

(51) Int. Cl. H04R 1/10; H04R 1/08

(52) U.S. Cl. CPC H04R 1/1066; H04R 1/083; H04R 1/105; H04R 1/1016; H04R 2201/107

(57) ABSTRACT

There is provided a headset having a holder which is of such a shape or configuration that it can be laid around the base of an ear of a user. The holder has a first end and a second end. The headset has an earmold unit or an ear fitting portion having an electroacoustic reproduction transducer and also a plug unit for electrical and mechanical contacting of an earmold unit or an ear fitting portion. The plug unit is provided at the first end of the holder. A boom arm with a boom microphone is fixed by means of a fixing unit at the second end of the holder.

The present application claims priority from International Patent Application No. PCT/EP2015/055075 filed on Mar. 11, 2015, which claims priority from German Patent Application No. 10 2014 204 405.7 filed on Mar. 11, 2014, the disclosures of which are incorporated herein by reference in their entirety.

### FIELD OF THE INVENTION

It is noted that citation or identification of any document in this application is not an admission that such document is available as prior art to the present invention.

The present invention concerns a headset.

In the professional area like for example in the case of musicians or in television the users of an in-ear monitor system typically use an otoplastic or earmold which is precisely fitted to the ear of the user. The earmold typically has an electrical connection and an electroacoustic transducer. The connecting cable for the electroacoustic transducer of the earmold is typically laid around the ear of the user. For that purpose, a wire can be provided in the cable in order to be able to correspondingly bend the cable.

In the German patent application from which priority is claimed the German Patent and Trade Mark Office searched the following documents: U.S. Pat. No. 6,396,935 B1, US 2009/0176538 A1, DE 10046202 A1, DE 102004056053 A1 and DE 102006016052 A1.

If the user of the in-ear monitor system also wishes to speak then in many places there is provided a boom microphone having a neckband.

### SUMMARY OF THE INVENTION

The object of the present invention is to provide a headset which permits good wearing comfort and ease of adjustability.

Thus there is provided a headset having a holder which is of such a shape or configuration that it can be fitted around the base of the ear of a user. The holder has a first end and a second end. The headset has an earmold unit or an ear fitting portion having an electroacoustic reproduction transducer and also a plug unit for electrical and mechanical contacting of an earmold unit or the ear fitting portion. The plug unit is provided at the first end of the holder. A boom arm having a boom microphone is fixed by means of a fixing unit at the second end of the holder.

In an aspect of the invention in the worn state the second end of the holder projects out under an ear of a user. In that way the boom arm with the boom microphone can be comfortably worn and the boom arm can stick out forwardly from under the ear of the user so that the boom microphone can record the audio signals or speech of the user.

In a further aspect of the present invention the earmold has a plug unit which can cooperate with the plug unit at the first end of the holder for mechanical and/or electrical contacting.

The invention concerns a notion of providing a headset having a holder which is so designed that it can be placed behind an ear or at the base of the ear of a user. A plug for mechanical and/or electrical contacting of an earmold or an ear fitting portion with an electroacoustic reproduction transducer can be provided on the holder at a first end. In the state of being worn the second end of the holder projects out under or behind the ear of the user. A boom arm having a boom microphone can be fixed at the second end. Because the holder enjoys sufficient mechanical stability the entire headset comprising the earmold or the ear fitting portion, the holder and the boom microphone is mechanically stable. The headset according to the invention is advantageous because now only one unit has to be placed on the ear of the user and thus it is possible to provide an in-ear monitor function as well as a boom microphone.

The invention also concerns a holder for a headset. The holder is so shaped that it can be laid around the base of an ear of a user. The holder has a first and a second end. The holder has a plug unit for electrical and mechanical contacting of an earmold unit or an ear fitting portion with an electroacoustic reproduction transducer. The plug unit is provided at the first end of the holder. Provided at the second end of the holder is a boom arm having a boom microphone which is fixed at the second end by means of a fixing unit.

According to the invention fixing of the headset is effected only at one side of the user. The headset can thus be fixed in a simple fashion. The headset further affords good mechanical stability for the earmold or the ear fitting portion and the microphone. By virtue of the fact that the holder has a plug for an earmold at its first end the holder can be used for different users as the holder is not fixedly connected to the earmold. If the plug at the first end of the holder is plugged into a corresponding socket of the earmold then good mechanical stability can be achieved.

### BRIEF DESCRIPTION OF THE DRAWINGS

FIG. 1 shows a diagrammatic view of a headset according to the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

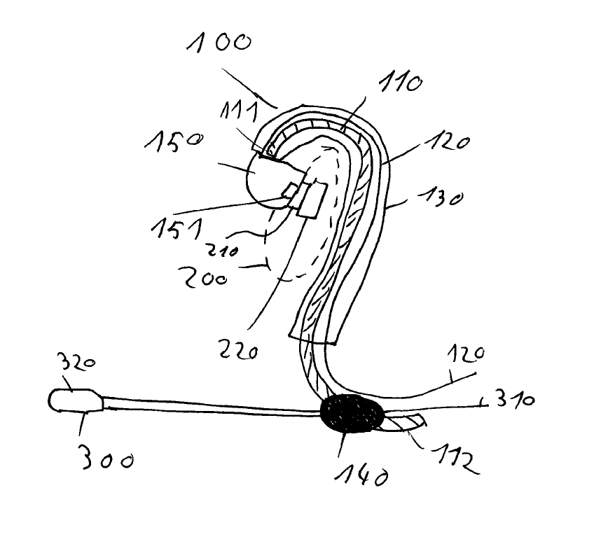

FIG. 1 shows a diagrammatic view of a headset according to the invention. The headset 100 has a holder 110 which is so designed that it can be arranged around an ear or the base of the ear (that is to say the transition between the auricle and the head) of a user. The holder can be worn behind the auricle. In that way the holder 110 can be worn behind an ear of the user. The headset 100 further has at a first end 111 of the holder 110 a plug unit 150 for an earmold or an ear fitting portion 200. The earmold or the ear fitting portion 200 can have a plug connection or plug unit 210 which can cooperate with the plug connection 151 of the plug unit 150. The earmold or the ear fitting portion 200 can have an electroacoustic reproduction transducer unit 220. The plug connection 151 is electrically connected to a cable 120 which extends at least partially along the holder 110 or is at least partially enclosed by the holder 110. A plug can be mounted or arranged at the free end of the cable 120. The cable 120 serves to pass an audio signal to the electroacoustic reproduction transducer 220 of the earmold or the ear fitting portion.

The holder 110 can be flexible so that the user can put the holder 110 into the shape that the user wants and that shape is then also retained by the holder so that the holder 110 can be comfortably fitted to the base of the ear of the user. The holder 110 can be in the form of a flexible shape-retaining wire.

Optionally a plastic sleeve or another casing 130 can be provided around the holder 110 and the cable 120. A fixing unit 140 for fixing a boom arm 300 can be provided in the region of the second end 112 of the holder 110 which projects from beneath the ear of the user when the headset is being worn. The boom arm 300 can have a boom microphone 320 and a cable 310, by way of which the audio signals detected by the boom microphone can be output.

According to the invention therefore there can be provided a firm (but removable) holding action in respect of the boom microphone 300 on the holder 110. Provided at the first end 111 of the holder 110 is the plug unit 150 to which the earmold or the ear fitting portion 200 can be connected to make an electrical connection.

The earmold 200 can be inserted into an ear of a user. Then the holder 110 can be laid around the ear and the electrical connection of the earmold or the ear fitting portion can be connected to the plug connection 150. As an alternative thereto the earmold 200 is fixed to the plug unit 150 and then the entire unit, that is to say the headset, can be fitted in place. It is thus possible to provide a simple, quick and compact solution. The boom microphone 300 can be firmly (but removably) connected to the second end 112 of the holder by way of the fixing unit 140 like for example a fixing clip 140. That therefore provides a headset comprising an earmold, a holder 110, a fixing unit 140 and a boom microphone 300.

The plug connection between the plug unit 150 and the earmold or the ear fitting portion is adapted to be removable.

An earmold or an ear fitting unit according to the invention represents an ear fitting portion which is fitted by a hearing aid acoustician. An earmold is thus a shaped fitting portion which is matched to an ear or an ear canal of a user. Thus the earmold is individually fitted to an ear or an ear canal of a user. An earmold can be produced for example by individual molding taken from the ear. For producing an earmold therefore an impression is taken in particular of the external auditory canal of the user. The earmold can be produced from plastic (acryl or silicone and mixtures thereof). In addition the plastics can be glazed or gold-plated. It is also possible to use Neutacryl, Thermotec etc as the plastic.

The function of an earmold unit can also be implemented by an ear fitting portion which for example has an elastic foam and which can be adapted in its shape to the shape of the ear or the external auditory canal of a user. According to the invention the ear fitting portion can also have soft deformable plastic pieces which permit the ear fitting portion to adapt to the shape of the auditory canal or ear canal of the user.

The ear fitting portion or the earmold (and the (precise) adaptation thereof to the individual ear of the user) can permit a secure hold in the ear and optionally provide for sealing off the ear canal in relation to ambient noise. In addition improved wearing comfort is achieved by the individually adapted ear fitting portion or the earmold.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A headset comprising:
a holder that is shaped so as to fit around the base of an ear of a user or to fit behind an auricle of the user, the holder having a first end and a second end;
an earmold unit or an ear fitting portion comprising an electroacoustic reproduction transducer;
a first plug unit provided at the first end of the holder, and configured to electrically and mechanically contact the earmold unit or the ear fitting portion; and
a boom arm that comprises a boom microphone, the boom arm being fixed to the second end of the holder by a fixing unit.

2. The headset as set forth in claim 1:
wherein the second end of the holder, in a state of being worn, sticks out under the auricle of a user.

3. The headset as set forth in claim 1:
wherein the earmold unit or the ear fitting portion further comprises a second plug unit, the second plug unit cooperating with the first plug unit to electrically and mechanically contact the earmold unit or the ear fitting portion.

4. The headset as set forth in claim 1:
wherein the holder is in the form of a flexible shape-retaining wire.

5. The headset as set forth in claim 1, further comprising:
an electrical cable configured to electrically contact the electroacoustic reproduction transducer;
wherein the electrical cable is at least partially enclosed by the holder, or the electrical cable together with the holder are at least partially enclosed by a casing.

6. A holder for a headset comprising:
a first end and a second end;
a plug unit configured to electrically and mechanically contact an earmold unit that has an electroacoustic reproduction transducer, wherein the plug unit is provided at the first end of the holder; and
a boom arm that comprises a boom microphone, the boom arm being fixed at the second end of the holder by means of a fixing unit;
wherein the holder is shaped so as to fit around the base of an ear of a user or to fit behind an article of the user.
